(19) United States
(12) Patent Application Publication
(10) Pub. No.: US 2003/0071839 A1
(43) Pub. Date: Apr. 17, 2003

(54) Method of presenting adjustable multi-channel sound field when multimedia software is playing audio data

(75) Inventors: Yung-Chiuan Weng, Taipei (TW); Min-Yuan Chen, Taipei (TW)

Correspondence Address: NIXON PEABODY, LLP, 8180 GREENSBORO DRIVE, SUITE 800, MCLEAN, VA, 22102, US

(73) Assignee: CYBERLINK CORPORATION

(21) Appl. No.: 10/270,562

(22) Filed: Oct. 16, 2002

(30) Foreign Application Priority Data
Oct. 16, 2001 (TW) 090125527

(51) Int. Cl. G09G 5/00

(52) U.S. Cl. 345/716; 345/727

(57) ABSTRACT

The present invention is related to a method of presenting adjustable multi-channel sound field over a display device when a multimedia software is playing an audio data through a speaker system. The present invention is provided to a user to adjust sound field and obtain a real time sound field after being adjusted with limited facilities. The present invention generates a virtual sound field interface on a display device, the virtual sound field interface including a user position and at least a movable virtual sound source. Each virtual sound source is at a corresponding position. Then, the present invention adjusts a position of the movable virtual sound source to obtain a corresponding real time sound field.

This application claims priority of Taiwan Patent Application No.090125527 filed on Oct. 16, 2001.

### FIELD OF THE INVENTION

The present invention is related to a method of presenting adjustable multi-channel sound field. More particularly, the present invention is related to a method of presenting adjustable multi-channel sound field over a display device when a multimedia software is playing audio data through a speaker system.

### BACKGROUND OF THE INVENTION

In the past, people enjoyed a musical performance of surrounding sound field only in a theater through the expensive audio appliances of the theater class. With the progress of technology, the household musical appliances industry provides the equipment of so-called “Home Theater”. With a television, an amplifier, and speakers, etc., people can enjoy the surrounding sound field of theater class at home.

The prime factor for achieving multi-channel sound field is the combination of multiple speakers. In general, there are 4.1 and 5.1 channels of the combination of multiple speakers respectively. The “0.1” here infers to the Low-Frequency heavy bass Effects. Because the low frequency heavy bass has no direction character, the low frequency heavy bass effect can be presented through a single channel. The “Home Theater” generally uses a 5.1 system, with five full-bandwidth audio tracks (front left, center, front right, rear left, rear right) and a Low-Frequency Effects channel for special bass effect.

Now, even a computer with two speakers can present the surrounding sound field. Using a audio play software having decoding function and a multi-channel sound card, two speakers are enough to demonstrate the multi-channel effect. Formerly, a user may adjust the position of sound sources over a display device by using demo program of sound card. However, there is still no technology bringing this approach into multimedia software. There is still no technology provided for a user to adjust the position of sound sources over a display device and change the sound field when multimedia software is playing audio data.

### SUMMARY OF THE INVENTION

The present invention provides a virtual sound field interface and a virtual sound source for a user to adjust the corresponding channel position of virtual sound source and to change the sound field. One aspect of the present invention is to provide a method and a virtual interface for a user to adjust the position of virtual sound source in the virtual sound field interface with limited facilities and to obtain the real time sound field after being adjusted.

The present invention provides a method of presenting adjustable multi-channel sound field when a multimedia software is playing audio data. First, the present invention generates a virtual sound field interface on a display device, the virtual sound field interface including a user position and at least a movable virtual sound source. Each virtual sound source is at a corresponding position. Then, adjust a position of the movable virtual sound source to obtain a corresponding real time sound field. Furthermore, the present invention records the position of the movable virtual sound source and sets the adjusted position to be a default value of the virtual sound source for a succeeding adjustment.

The application software applied in the present invention is limited to DVD Player software, Digital TV software, Information Appliances software, Digital Video Recorder software, and Distributed Virtual Environment, etc.

### BRIEF DESCRIPTION OF THE DRAWINGS

The novel futures and believed characteristics of the invention are set forth in the appended claims. The invention itself, however, as well as preferred mode of use, further objectives and advantages thereof, will best be understood by reference to the following detailed description of an illustrative embodiment when read in conjunction with the accompanying drawings, wherein:

FIG. 1 shows a virtual sound field interface of the present invention, the interface including a fixed user position and multiple virtual sound sources positions.

FIG. 2 shows another virtual sound field interface of the present invention, the interface including a fixed user position and multiple virtual sound sources positions.

FIG. 3 shows the flowchart of the method of the present invention for presenting multi-channel sound effect.

FIG. 4 shows three functions for sending parameters.

FIG. 5 shows the connecting relationships between DS3DBUFFER, DirectSound3Dbuffer and DirectSound Buffer interface.

### DESCRIPTION OF PREFERRED EMBODIMENTS

The present invention provides a method of presenting adjustable multi-channel sound field over a display device when a multimedia software is playing audio data through a speaker system. The present invention sets a virtual sound field interface for adjusting positions of virtual sound sources of the visualized virtual sound field interface. Adjusting the positions of sound sources, the present invention changes the effect of the sound field. The exemplary embodiment below illustrates the method of the present invention.

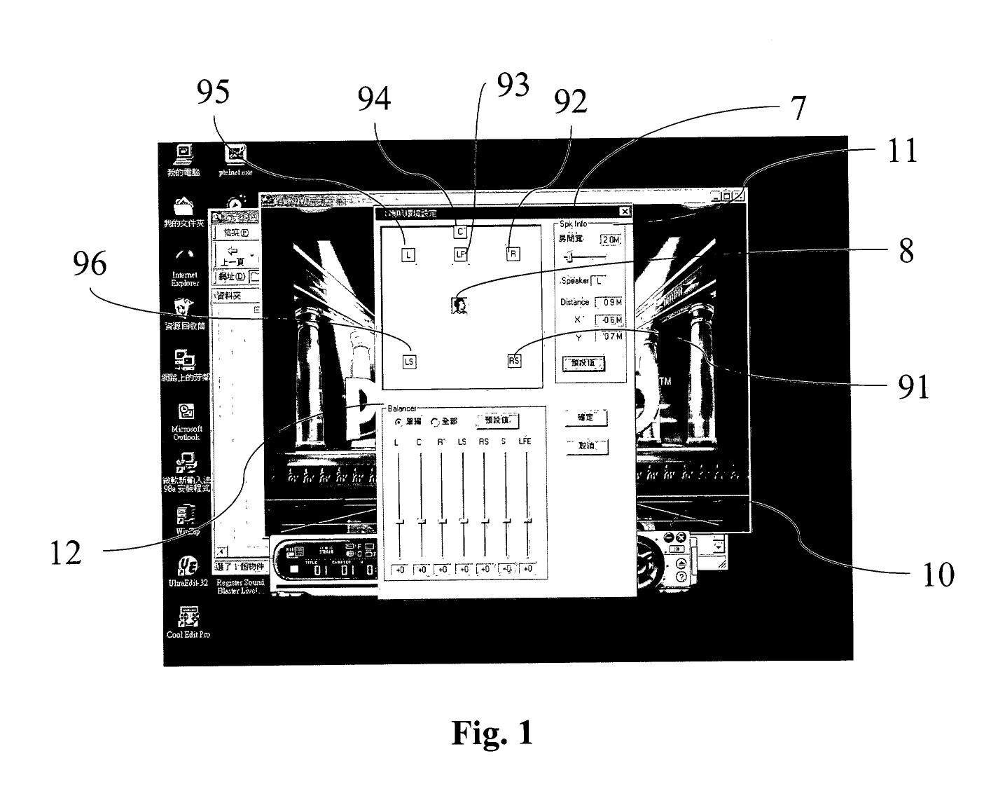

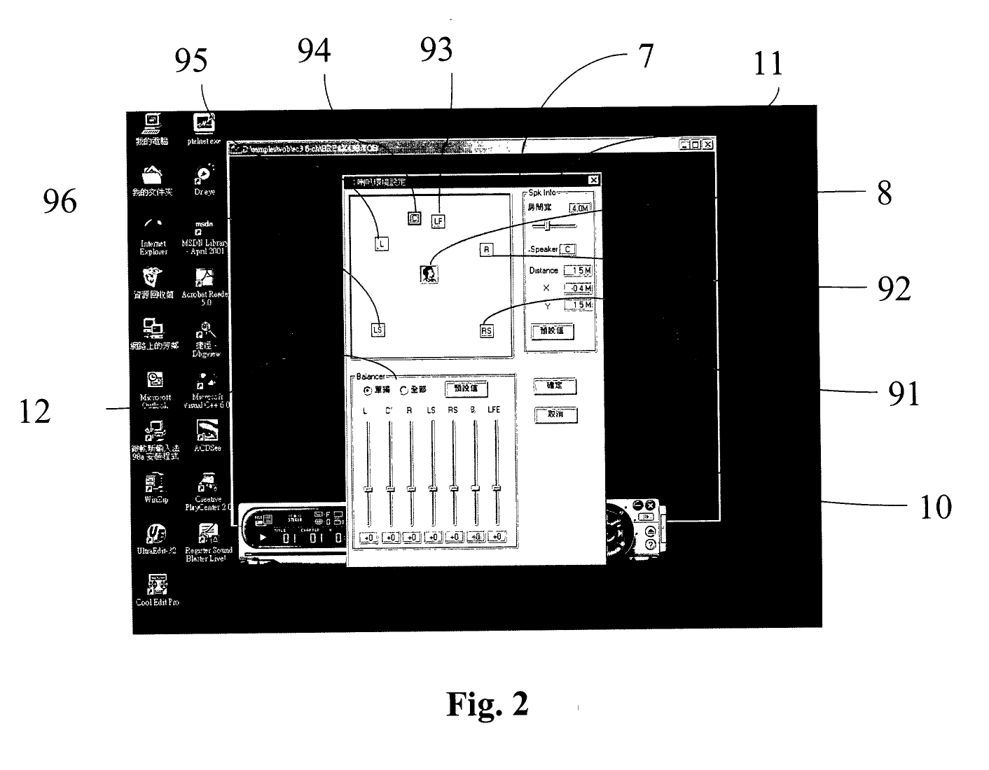

FIGS. 1 and 2 show the preferred embodiments of the present invention. Please refer to FIG. 1, the embodiment generates a virtual sound field interface 7 after opening application software interface 10 shown on the computer monitor. The virtual sound field interface includes a user position 8 and multiple virtual sound sources 91, 92, 93, 94, 95, and 96. Each of the virtual sound sources 91, 92, 93, 94, 95, and 96 respectively corresponds to a channel. A user may change the sound field by adjusting the position of the multiple virtual sound sources 91, 92, 93, 94, 95, and 96. In addition, the virtual sound field interface 7 also provides information of sound source 11 and channel balance 12, showing the size of the virtual sound field and the state of each sound source. As shown in FIG. 2, some virtual sound sources of the virtual sound field interface 7 are adjusted. According to the positions of the virtual sound sources which are adjusted, the present invention presents the corresponding sound field to the user in real time (or in less than 1 second).

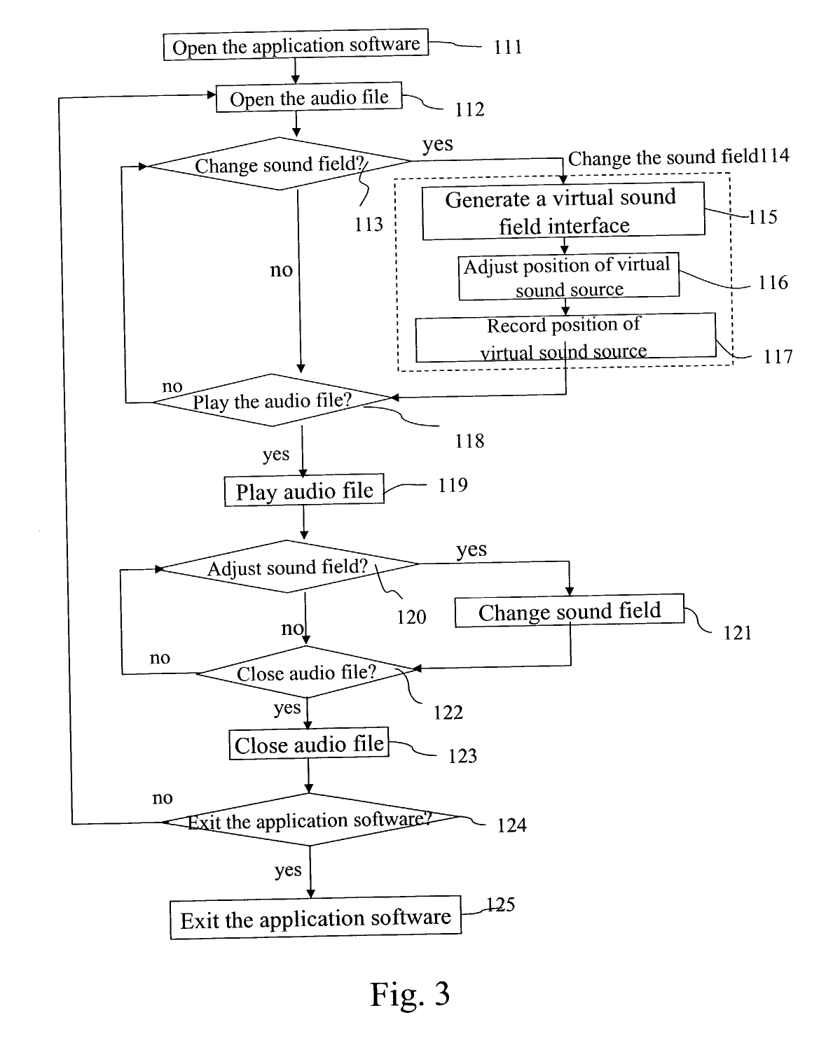

FIG. 3 shows the flowchart of the method of the present invention for presenting multi-channel sound effect. First, open an application software (step 111), and open a audio file (step 112). Then, user may selectively change the sound field (step 113). When the user chooses to change the effect of the sound field 114, the present invention generates a virtual sound field interface (step 115). The virtual sound field shows information and states of sound sources according to the audio mode of the audio file. The user may select a virtual sound source and adjust the position of the virtual sound source (step 116). The present invention records all positions of the virtual sound sources which are adjusted (step 117). After finishing adjusting the sound field, the user selects to play the audio file or not to play the audio file (step 118). The user may readjust the sound field (step 113) or play the audio file (step 119). Further, the user may directly play the audio file (step 119) after opening the audio file (step 113).

The user may select to adjust the sound field (step 120) after playing the audio file (step 115). He may select to change the sound field (step 121) or to close the audio file (step 122). After closing the audio file (step 123), the user selects (step 124) to exit the application software (step 125), or reopen an audio file (step 112). Before exiting the application software (step 125), the present invention records all positions of the virtual sound sources. The record is the default value for next time adjustment.

The application software applied in the present invention is limited to DVD Player software, Digital TV software, Information Appliances software, Digital Video Recorder software, and Distributed Virtual Environment, etc.

Because providing multiple virtual sound sources corresponding to multiple channels for user to change the sound field, the present invention uses buffers to save the record of each channel and uses data structure to record the position of each virtual sound source. Furthermore, the present invention sets three functions for sending parameter such as the names and positions of the virtual sound sources to different interfaces. The functions cover all behaviors of a user adjusting sound source in the virtual sound field.

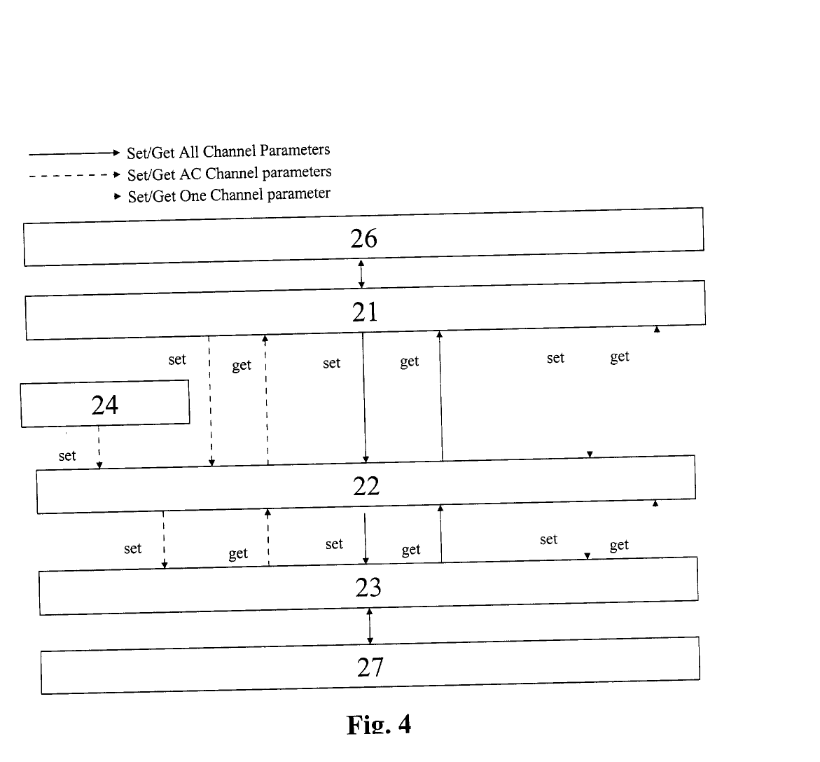

FIG. 4 shows an example of using software DVD player on a personal computer. The three functions of the present invention include the contents and sending directions of the parameters. The three functions is used for sending parameters between an user interface 21, an audio application programming interface 22 and renderer 23. The user interface 21 displays the information of the virtual sound sources 26 of the virtual sound field 21. The renderer 23 communicates with a sound card 27. The three functions are:

1. Set/Get All Channel Parameters: If a user wants to adjust the channel positions to the default value, he will need to obtain all information of the virtual source form the virtual sound field no matter when obtaining the default values of all channel form the registry or when a application software is playing audio data. Similarly, the audio application programming interface 22 needs to obtain the information of all sound source for presenting the sound field. The audio application programming interface 22 and the user interface 21 need to set or get all channel parameters.

2. Set/Get AC Channel Parameters: When the application software is playing the audio data, decoder sets the audio mode of the audio data in the audio application programming interface. In addition, the user interface needs to obtain the audio mode for presenting the information of virtual sound sources. The user interface also sends back the parameters of positions of virtual sound sources to the audio application programming interface to set or get the audio mode which is being used.

3. Set/Get One Channel Parameter: A user needs to assign a virtual sound source of the virtual sound field and adjust the assigned virtual sound source when he wants to change the position of channel. Meanwhile, the user interface and audio application programming interface set or get a channel parameter according to the parameter information of the virtual sound source the user adjusted.

When the audio application programming interface 22 which is not connected with the renderer 23 processes the parameters, all parameters are recorded in the audio application programming interface 22. A user has to get the parameter information form the audio application programming interface 22. When the audio application programming interface 22 is connected with the renderer 23 and all parameters of channel positions are adjusted, All parameters are set to the 3D buffers. In the renderer 23, each channel uses a 3D buffer for reducing the loading of the central processing unit and accelerating the process speed of the information. For instance, the present invention utilizes the interface provided by DirectSound3D of Microsoft DirectX to communicate with a sound card 27. The present invention utilizes the firmware function of 3D accelerating of the sound card to reduce the consumption of system resource and changes the parameter of DS3DBUFFER with the functions provided by the interface.

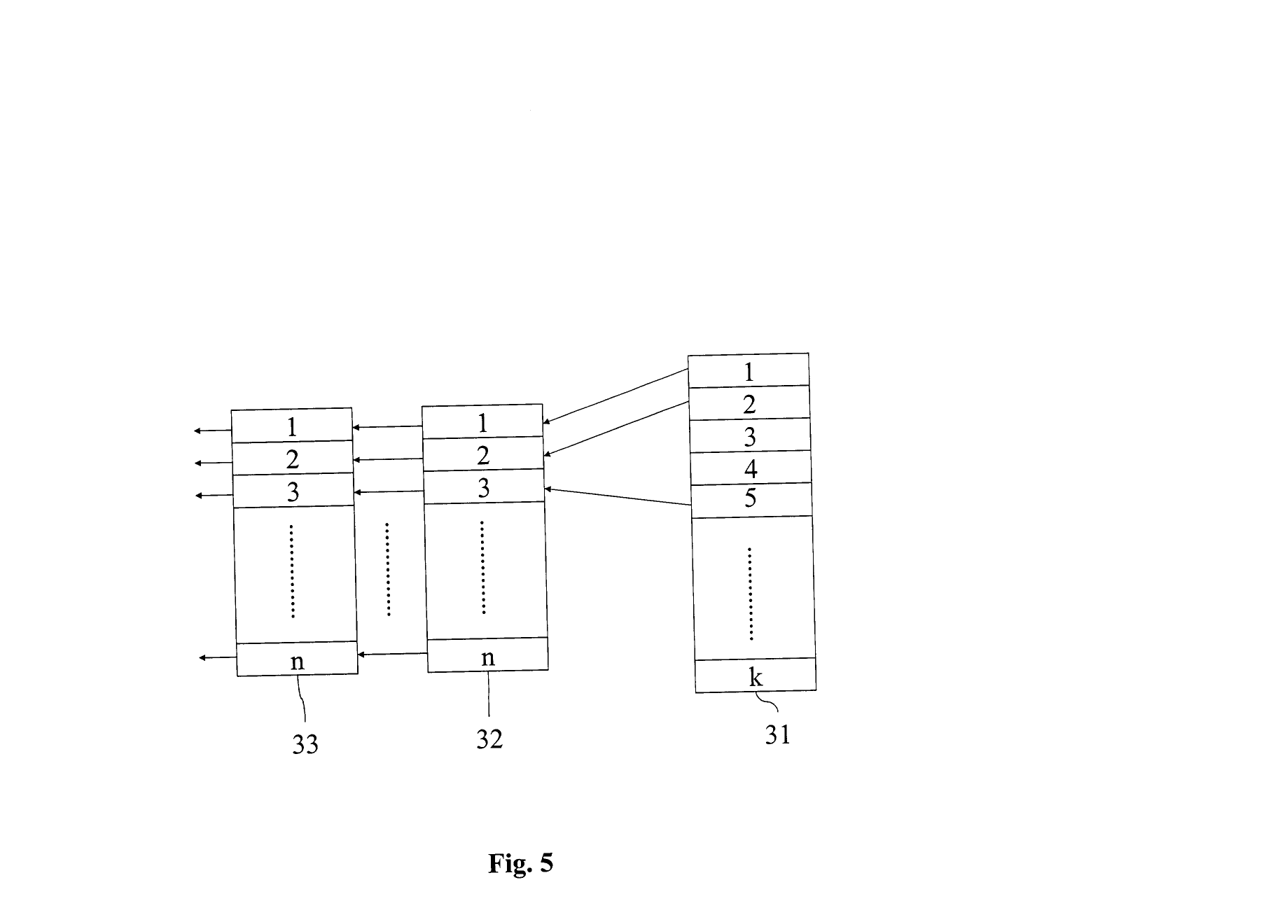

Except the standard procedure of connecting interfaces of DirectSound, the present invention connects the DirectSoundBuffer interface to the DirectSoundBuffer interface by a method of mapping. As shown in FIG. 5, the relationship between the DirectSoundBuffer interface to the DirectSoundBuffer interface is one to one. The number of interface is decided by the number of audio channel. The number of DS3DBUFFER 31 is decided by the definition of the present invention. If there are n channels of an audio data, the present invention will set n DirectSoundBuffer interfaces and n DirectSound3Dbuffer interfaces. Further, the present invention assigns a DS3DBUFFER to each of the predetermined k channels. The present invention connects the DS3DBUFFER which been used and the DirectSound3Dbuffer interface when setting the channel parameters.

However, not every relationship between DirectSound3Dbuffer interface 32 to DS3DBUFFER 31 is one to one. For instance, the embodiment of the present invention devises up to 7 channels (the order is front left, front right, back left, back right, front center, back center, subwoofer). The present invention sets 3 DirectSoundBuffer interfaces and 3 DirectSound3Dbuffer interfaces and 7 DS3Dbuffers according to a audio data having 3 channels (front left, front right and front center). In the 7 DS3Dbuffers, the first (front left), the second (front right), and the fifth (front center) respectively save the channel information of the audio data. The first DS3Dbuffer is connected with the first DirectSound3Dbuffer interface. The second DS3Dbuffer is connected with the second DirectSound3Dbuffer interface. The fifth DS3Dbuffer is connected with the third DirectSound3Dbuffer interface.

The speakers play the sound effect of the audio mode via the sound Card. The virtual sound field interface presents the audio mode in real time after the present invention processed the parameter of DS3Dbuffer. When the user readjusts the positions of virtual sound source, the virtual sound field interface shows a new audio mode of the output sound field. Last, the user interface saves all positions of virtual sound sources in the registry after exiting the application software. The positions of virtual sound sources in the registry will be the default vales of the succedding adjustment.

While the invention has been described in connection with what is presently considered to be the most practical and preferred embodiments, it is to be understood that the invention is not to be limited to the discovered embodiments. The invention is intended to cover various modifications and equivalent arrangement included within the spirit and scope of the appended claims.

1. A method of presenting adjustable multi-channel sound field over a display device when a multimedia software is playing an audio data through a speaker system, comprising:
generating a virtual sound field interface on the display device, said virtual sound field interface including a user position and at least a movable virtual sound source; and
adjusting a position of said movable virtual sound source to obtain a corresponding real time sound field.

2. The method of claim 1, wherein said multimedia software is a DVD Player software.

3. The method of claim 1, wherein said multimedia software is a Digital TV software.

4. The method of claim 1, wherein said multimedia software is an Information Appliances software.

5. The method of claim 1, wherein said multimedia software is a Digital Video Recorder software.

6. The method of claim 1, wherein said multimedia software is a Distributed Virtual Environment software.

7. The method of claim 1, wherein each of said virtual sound sources corresponds to a channel.

8. The method of claim 1, wherein said corresponding sound field effect is obtained in less than one second.

9. The method of claim 1, further comprising:
recording the position of the movable virtual sound source after being adjusted; and
setting the adjusted position to be a default value of the movable virtual sound source for a succeeding adjustment.

10. A virtual interface of presenting adjustable multi-channel sound field over a display device when a multimedia software is playing an audio data through a speaker system, comprising:
a user position; and
at least a movable virtual sound source used for being adjusted by a user to obtain a corresponding real time sound field.

11. The virtual interface of claim 10, wherein said multimedia software is a DVD Player software.

12. The virtual interface of claim 10, wherein said multimedia software is a Digital TV software.

13. The virtual interface of claim 10, wherein said multimedia software is an Information Appliances software.

14. The virtual interface of claim 10, wherein said multimedia software is a Digital Video Recorder software.

15. The virtual interface of claim 10, wherein said multimedia software is a Distributed Virtual Environment software.

16. The virtual interface of claim 10, wherein each of said virtual sound sources corresponds to a channel.
